(19) United States
(12) Patent Application Publication
(10) Pub. No.: US 2025/0193072 A1
(43) Pub. Date: Jun. 12, 2025

(54) NEXT GENERATION ZERO TOUCH PROVISIONING OF NETWORK DEVICES

(71) Applicant: Arista Networks, Inc., Santa Clara, CA (US)

(72) Inventors: Aparna Karanjkar, Cupertino, CA (US); Prateek Nigam, Bengaluru (IN); Joseph Garcia, Santa Clara, CA (US); Saurabh Singhal, Bangalore (IN)

(21) Appl. No.: 18/536,667

(22) Filed: Dec. 12, 2023

(51) Int. Cl. H04L 41/0806; H04L 41/08; H04L 41/084

(52) U.S. Cl. CPC H04L 41/0806; H04L 41/084; H04L 41/0886

(57) ABSTRACT

Next generation zero touch provisioning (NexGen ZTP) provides programmatic onboarding features that can benefit those who desire ZTP without requiring them to spend time and money to preprogram network devices with a designated URL for ZTP. Particularly, when a connection request is received from a network device, network device identification information contained in the connection request is used to search for a matching identifier stored in a centralized database. The centralized database stores historical transactions that record sales of network devices. If a matching identifier is found, an owner of the network device can be identified from a corresponding sales record using the matching identifier. Once the owner is identified, a tenant or suborganization of the owner is determined. The network device can then be directed to a configuration file or script corresponding to the tenant or suborganization for ZTP of the network device.

### TECHNICAL FIELD

This disclosure relates generally to network devices. More particularly, this disclosure relates to techniques for provisioning network devices without requiring user intervention.

### BACKGROUND OF THE RELATED ART

Network devices (e.g., routers, switches, access points, firewalls, gateways, networking appliances, etc.) are often installed by authorized users (e.g., administrators, site managers, technicians, installers, etc.) at remote sites who have limited, if any, networking expertise. In addition to cabling, network devices shipped from manufacturers need to be configured or otherwise set up correctly before they can operate on computer networks (e.g., an enterprise computing network) and communicate with other networked devices in a secure manner.

However, such a remote site (e.g., a customer-defined location, a branch office, etc.) often lacks specialized equipment (e.g., a capable laptop computer, a serial cable programmed to operate at a specific frequency and/or an Ethernet cable for a secure shell (SSH) connectivity, etc.), as well as computer programs required to connect the network device to a network management service capable of performing operations, administration, maintenance, and provisioning (OAMP) functionalities.

Even when connected and configured properly, the network device may still not be able to connect to the network if dynamic host configuration protocol (DHCP) and/or other service discovery features are unavailable. Additionally, a misconfiguration in the network device could result in a security breach. As a result, a provider (e.g., a manufacturer) of the network device must dispatch a more experienced network engineer to troubleshoot the site connectivity and properly configure the network device, which increases deployment costs, inefficiency, and complexity for both the network device owner and the provider.

### BRIEF DESCRIPTION OF DRAWINGS

The drawings accompanying and forming part of this specification are included to depict certain aspects of the disclosure. It should be noted that the features illustrated in the drawings are not necessarily drawn to scale. A more complete understanding of the disclosure and the advantages thereof may be acquired by referring to the following description, taken in conjunction with the accompanying drawings in which like reference numbers indicate like features.

FIG. 1.1 shows a system for provisioning a network device according to some embodiments disclosed herein.

FIG. 1.2 shows a diagram of an example user device according to some embodiments disclosed herein.

FIGS. 2.1-2.4 show a flowchart for bootstrapping a network device according to some embodiments disclosed herein.

FIG. 2.5 shows a flowchart for app-assisted onboarding of a network device according to some embodiments disclosed herein

FIG. 3 shows a flowchart for an example of an expected device workflow according to some embodiments disclosed herein.

FIG. 4 shows a diagram of a computing device for implementing some embodiments disclosed herein.

### DETAILED DESCRIPTION

Specific embodiments will now be described with reference to the accompanying figures (FIGS). The figures and the following description describe certain embodiments by way of illustration only. One skilled in the art will readily recognize from the following description that alternative embodiments of the structures and methods illustrated herein may be employed without departing from the principles described herein. It is noted that wherever practicable similar or like reference numbers may be used in the figures and may indicate similar or like functionality.

Zero Touch Provisioning (ZTP) is a networking technology that allows users to initially provision certain network devices automatically with minimal manual intervention. ZTP automates steps like updating operating systems, deploying patches, fixing bugs, and implementing desired features prior to connection. Once installed, ZTP-enabled network devices would enter the ZTP mode when powering up, without a start-up configuration.

Generally, when bootstrapping a network device (e.g., a switch, a router, an access point, a firewall, a networking appliance, etc.) to a computer network, the network device is programmed to try to conduct a ZTP with a network management service providing the configuration that the network device needs. The network management service may be hosted on a cloud-based multi-domain management platform which enables zero-touch network operations with enterprise-wide consistent operations such as network-wide workload orchestration and work flow automation.

From the perspective of an installer, only three steps are necessary-mount the network device, connect the network device to a computer network, and power on the network device. The network device is programmed with a universal resource locator (URL) that directs the network device to obtain/download a configuration file or script for configuring the network device. The resource location where the configuration file or script resides may be on the premises of an enterprise (e.g., a ZTP server) or in the cloud (e.g., through the network management service hosted on the cloud-based multi-domain management platform).

For instance, a network device installed on the premises of an enterprise can use a ZTP-token embedded on the network device at the factory to programmatically download a script from the cloud (via the network management service), executes the script, and registers itself with the cloud-based multi-domain management platform. An issue here is that some network devices may not be programmed at factory with such an embedded URL for ZTP.

If a network device is not embedded with a ZTP-token (e.g., a URL for ZTP), it may need to obtain one first (e.g., via the network management service hosted in the cloud), before it can download the configuration file or script from the designated URL. The invention disclosed herein provides the next generation ZTP (NexGen ZTP) with programmatic onboarding features that can handle such a situation, further enhance ZTP, and eliminate human intervention. These NexGen ZTP features include Expected Device Workflow, URL-Based Redirect Onboarding, App-Assisted Onboarding, and Correct Tenant Identification.

### Expected Device Workflow

This invention provides a programmatic onboarding approach referred to as “Expected Device Workflow” in which a new network device can programmatically get itself onboard, even if the network device is not embedded with or does not have a built-in URL that can direct the network device to retrieve or obtain a configuration file or script for configuring the network device.

In some embodiments, when the network management service hosted on the cloud-based multi-domain management platform receives a request from a new network device, it operates to recognize the network device by mapping an identifier (ID) provided by the network device (e.g., a device ID, MAC address, serial number, Internet Protocol (IP) address assigned by the Internet Assigned Numbers Authority (IANA), etc.) in the request with IDs stored in a centralized database. The manufacturer of the network device keeps track of network device sales information, which contains device particulars such as device IDs, serial numbers, and so on, in the centralized database. The centralized database is accessible by the network management service hosted on the cloud-based multi-domain management platform.

This mapping allows logic executing the Expected Device Workflow (e.g., a EDW engine) on a server machine of the cloud-based multi-domain management platform to identify an owner (e.g., an enterprise customer) to which the network device belongs. The EDW engine can then search another database (e.g., an owner database) or the same centralized database for information provided by the owner to determine which subset of the owner (e.g., a suborganization or tenant) into which the network device will be placed. An example of an owner could be a hyperscaler. The term “hyperscaler” generally refers to a massive company that owns data centers where clusters of server machines are housed and operated to serve multiple tenants. Multitenancy, hyperscaler, and data centers are known to those skilled in the art and thus are not further described herein.

Through these lookups, the EDW engine obtains the knowledge on: 1) the network device itself; 2) the owner of the network device; and 3) the suborganization or tenant for which the network device is to be configured. After these pre-provisioning steps are completed, control moves from the EDW to ZTP. Based on the knowledge thus gained, the new network device is directed to an appropriate configuration file or script for ZTP.

In the scenario described above, the new network device does not have a built-in URL that directs the new network device to a configuration file or script for ZTP. Rather, the new network is programmed to send a request to the cloud-based multi-domain management platform through the network management service. The request causes the new network device to enter an EDW which prepares the new network device for ZTP. In this way, the invention provides the next generation of ZTP in which a new network device can programmatically configure itself, even if the network device is not programmed with any URL that can lead the network device directly to a configuration file or script for ZTP.

### URL-Based Redirect Onboarding

In some cases, a network device may have a built-in script that contains or otherwise references a pre-selected URL. When the network device is initially starting up, the network device will attempt to connect to the pre-selected URL through the script built-in to the network device.

In some cases, a network device may not have information on precisely which URL to connect to the cloud-based multi-domain management platform. However, the network device may have a piece of code that is built into the network device. The built-in code directs the network device to go through different ways to download or otherwise obtain a URL where a ZTP configuration file or script resides and, when no other ways to get Internet connectivity, connect to a “default URL.” This process is referred to as URL-based redirect onboarding.

This URL-based redirect onboarding approach can represent a “last resort” to communicate with an extensible network operating system (ENOS) on the network device to detect where to trigger an EDW and complete the ZTP configuration for the network device. This new approach eliminates the need for a technician or installer of the network device to log into the network device in order to configure these details. Network device manufacturers often do not have control over on-site installations. Therefore, the ability for this new approach to eliminate such a significant operational difficulty is a huge advantage over prior approaches.

### App-Assisted Onboarding

This aspect of the invention relates to an approach that utilizes Bluetooth® to assist ZTP of network devices. As alluded to above, generally, a network device connects to a network management service that remotely bootstraps/troubleshoots the network device at sites lacking a professional installer. The network management service typically connects to the network device via Bluetooth®.

The NexGen ZTP goes further by using an onboarding application running on a user device (e.g., a mobile device such as a smart phone, a tablet, a laptop, etc.) with Internet connectivity. The onboarding application can be a type of user-facing application. Contrast with software that runs in the background which a user never sees, a user-facing application is an application with which a user interacts. In this case, the user of the onboarding application can be an installer of a new network device. The onboarding application is configured for downloading the minimum connection information for the network device (e.g., from the cloud-based multi-domain management platform) and for loading the minimum connection information thus downloaded onto the network device over a Bluetooth® connection between the application and the network device.

With the minimum connection information, the network device can connect to the cloud-based multi-domain management platform and start the Expected Device Workflow. This functionality is primarily useful for smaller Internet Service Providers (ISPs) and private networks (because they often do not provide necessary information (e.g., IP address, etc.) when the network device initially gets Internet connectivity. Larger ISPs tend to provide this information to the cloud-based multi-domain management platform that can then be used for configuring the network device.

As a non-limiting example, an installer of the network device may use their credentials to log in to the application on their user device. The application securely connects to a network management service executing on a management server of the cloud-based multi-domain management platform via a first communication interface (e.g., internet connectivity via cellular or Wi-Fi) to authenticate the user (i.e., the installer).

Once the user is authenticated, the application securely connects, via a communication channel using a second communication interface (e.g., Bluetooth®, a universal serial bus connection, etc.), to the network device. In general, the user device is commonplace and not under the administrative control of a provider of the application; the user device is used to establish connectivity to the network device by the installer; the user device is used by the installer to gain connectivity to the network management service; the user device may never be able to decrypt and see the network device configuration and/or troubleshoot data being sent/received from the network management service; network management service gets increased contextual data about the site location and can verify that the installer has physical access to the network device; and administrator (and or a network engineer) of the network management service can do all functions necessary for the network device to gain admission to the network (namely, when services such as Dynamic Host Configuration Protocol (DHCP) are not available).

Through the application on the user device, the network device can communicate with the network management service to download configurations, upload log files, etc. This way, a network administrator located at another location can remotely access the network device using to bootstrap and/or troubleshoot the network device.

For example, bootstrapping can be performed using mechanisms such as, but is not limited to: ZTP, RFC 8572 Secure ZTP, etc. Troubleshooting can be performed using connection mechanisms, including but not limited to: secure shell (SSH), electronic application programming interface (eAPI), etc. Once the network device completes processing of the configurations from the network management service (e.g., is bootstrapped to the network), a second communication channel is established directly between the network device and the network management service such that the network device can communicate directly with the network management service without going through the user device (i.e., the user device is not part of the second communication channel).

Further, once the network device completes the processing of the configurations from the network management service (e.g., is bootstrapped to the network), the network device disables its Bluetooth® functionality (i.e., disables the communication channel with the user device). This advantageously adds a layer of security such that the network device can only be accessed by an administrator of the network management service.

With this approach, the installer of the network device is not required to have any networking experience; the installation process is secure; multiple layers of device and user authentications are provided; the installation does not require any keyboard/console for troubleshooting; and the user device with the application is the only required equipment.

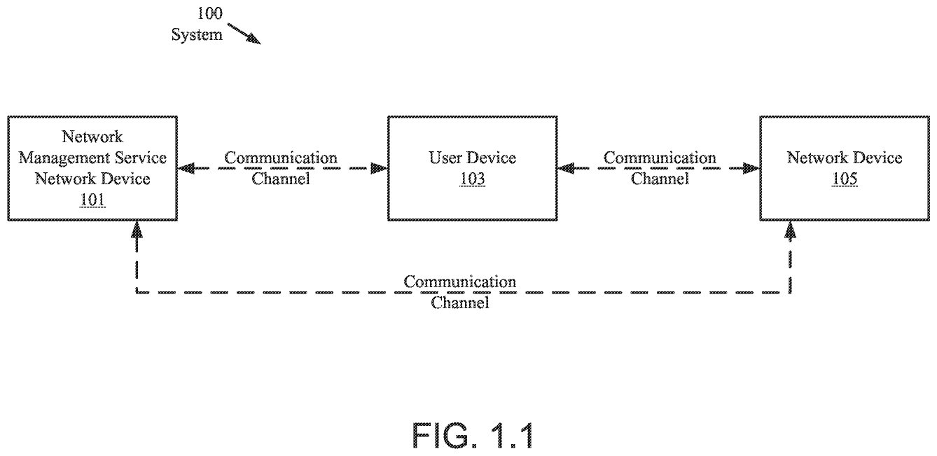

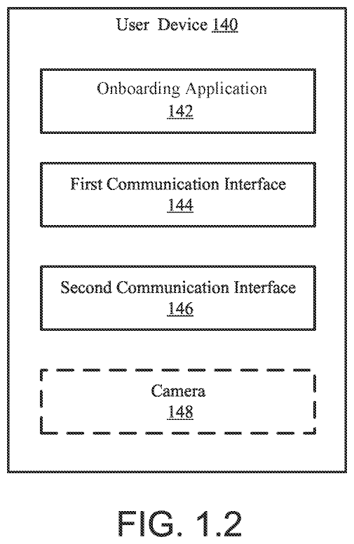

FIG. 1.1 shows a system (100) for app-assisted ZTP. The system (100) includes a network management service (101), a user device (103), and a network device (105). Each of these components is described below.

In one or more embodiments disclosed herein, the network management service (101) may provide a combination of services (e.g., network and network device maintenance, monitoring of attached network devices, authentication of an installer of a network device, implementation of upgrades and patches of network device, etc.), and may be executing as software on a server connected to a network. In one or more embodiments, the network management service (101) may be provided by a manufacturer of the network device (105). Alternatively, a provider of the network management service (101) may be different from the manufacturer of the network device (105).

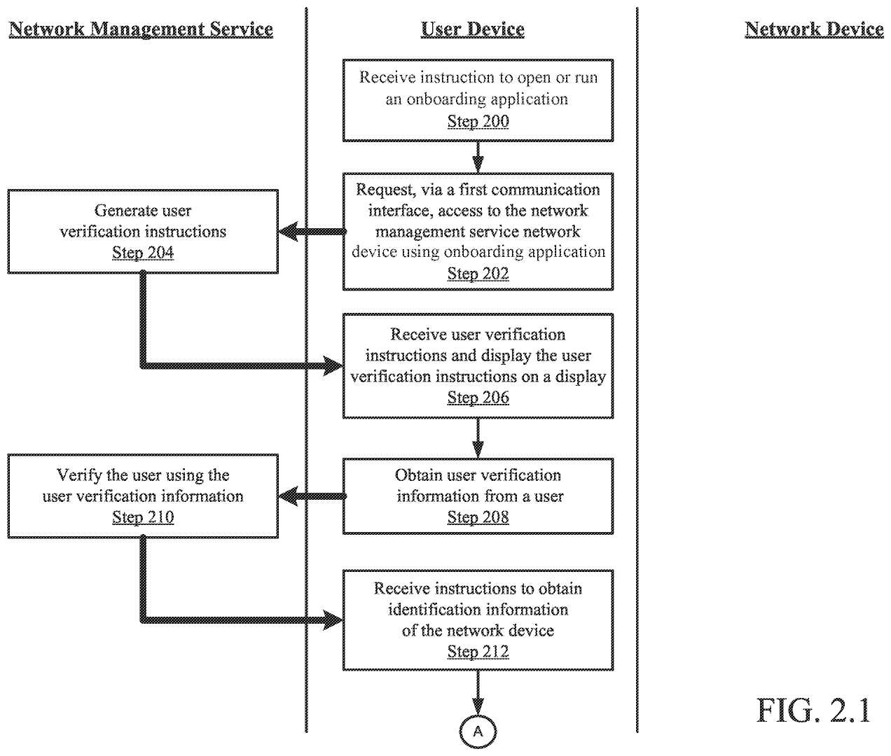

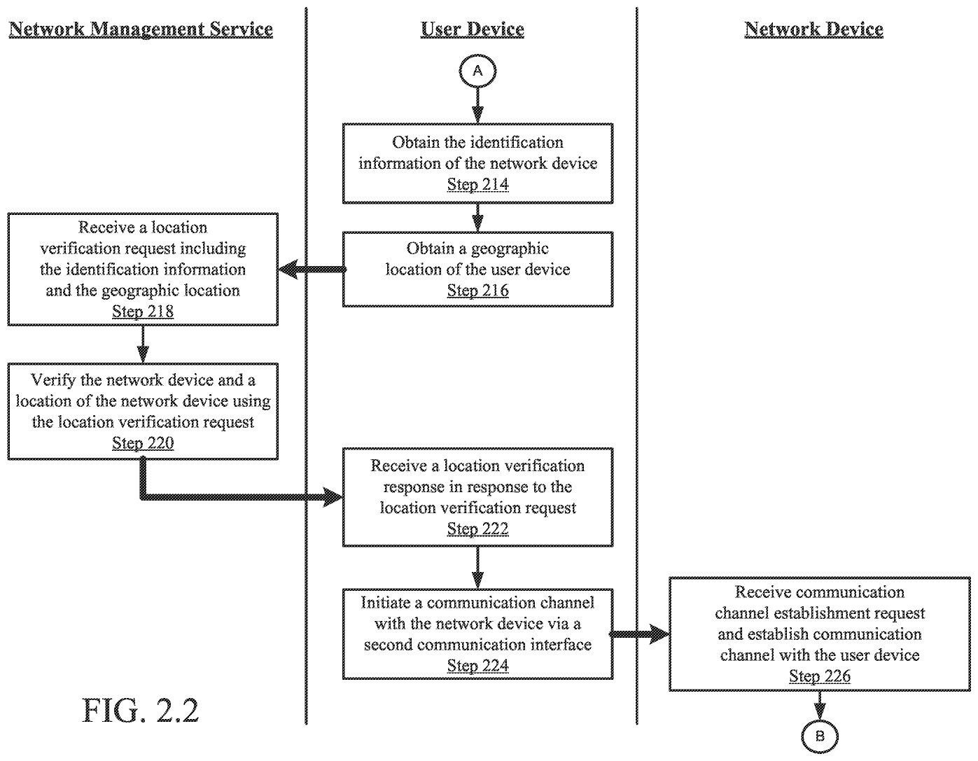

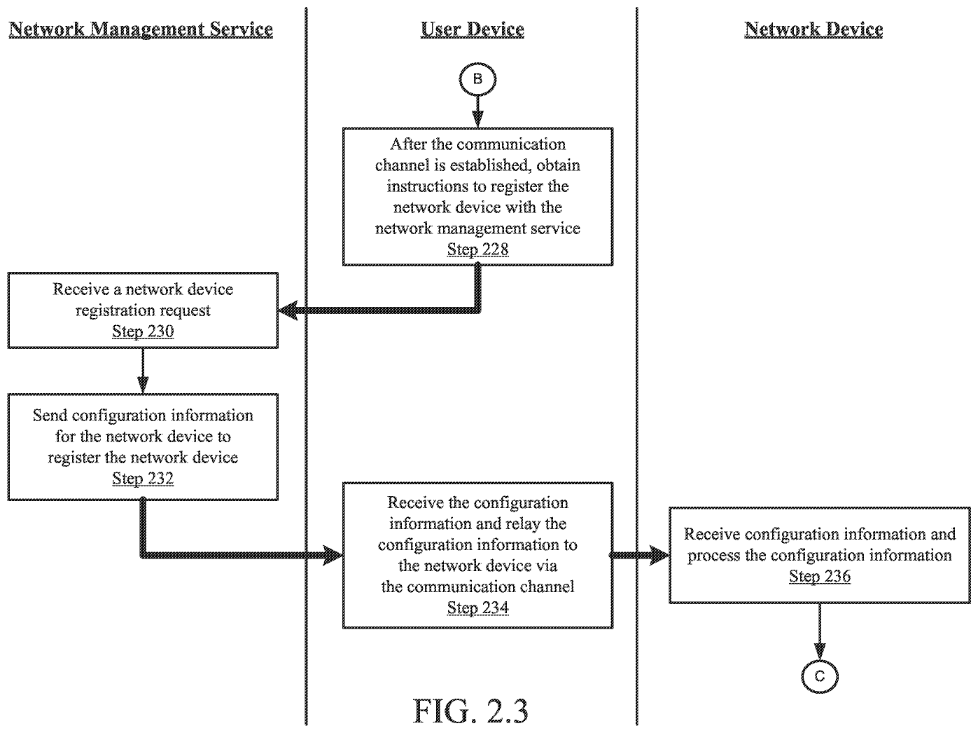

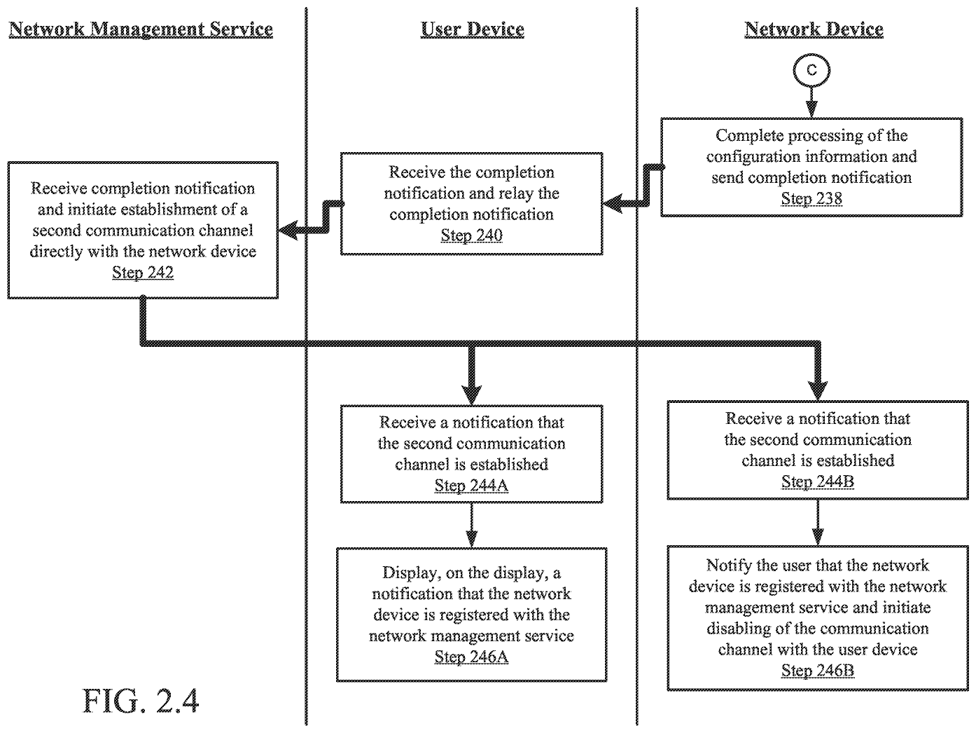

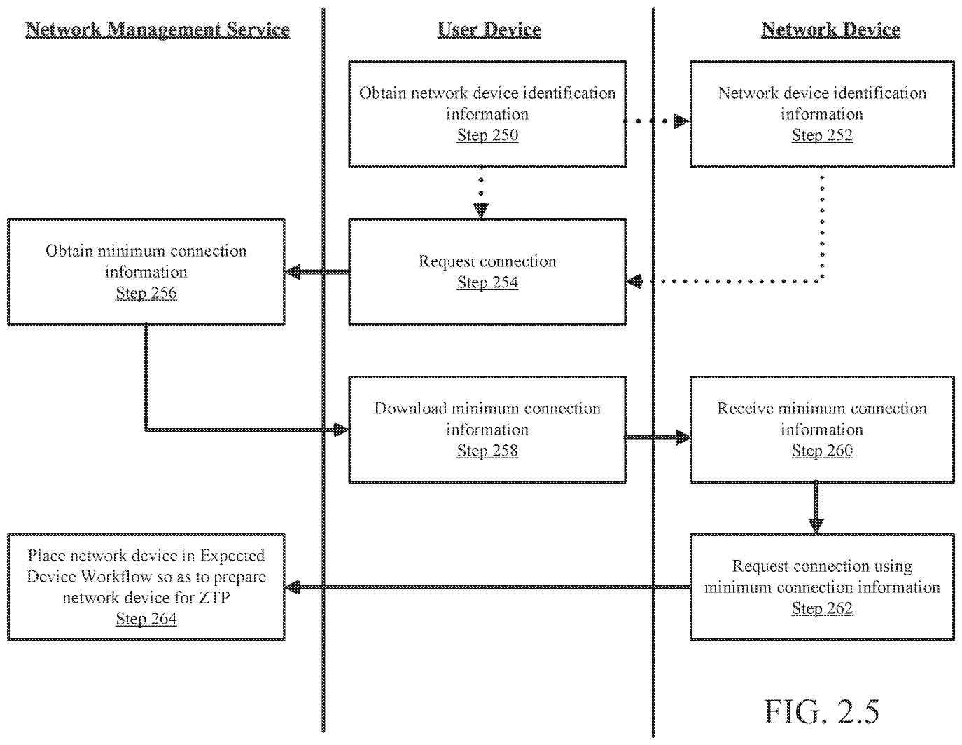

In one or more embodiments, the network management service (101) may be operated by an administrator associated with the manufacturer and/or the provider. The administrator may utilize functions and services of the network management service (101) to remotely (e.g., using zero-touch provisioning (ZTP)) bootstrap a network device (105) being installed at a remote site (e.g., a customer-defined location or a branch office) to the network. The administrator may also utilize the functions and services of the network management service (101) to remotely troubleshoot the network device (105). Additional details of the functions and services of the network management service (101) are described below with reference to FIGS. 2.1-2.4.

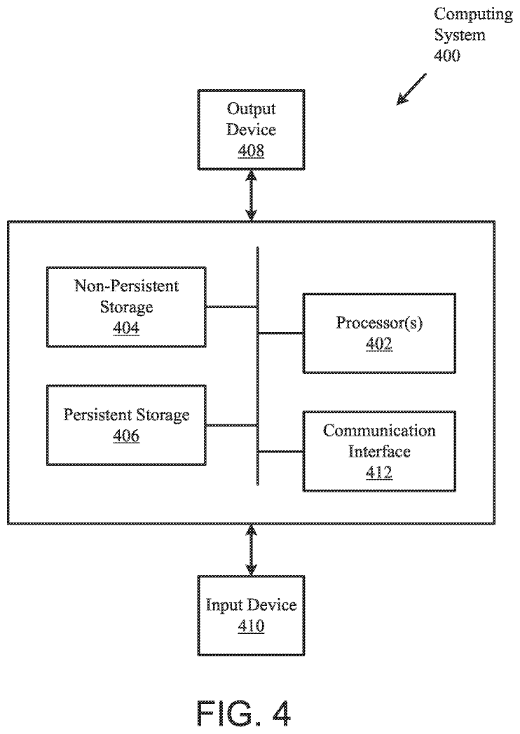

In one or more embodiments disclosed herein, the user device (103) may be a physical device (e.g., the computing system of FIG. 4) that includes persistent storage, memory (e.g., random access memory), and one or more processor(s). Examples of the user device (103) include, but are not limited to, a smartphone, a laptop computer, a tablet computer, etc. In one or more embodiments, the user device (103) may belong to a user installing the network device (105) at a site remote from a site hosting the server executing the network management service (101).

Additionally, the persistent storage in the user device (103) may include any type of non-transitory computer-readable medium that stores data. For example, the data in the persistent storage may be instructions, which, when executed by one or more processor(s) in the user device (103), enable the user device (103) to perform one or more functions of the user device (103) described below with reference to FIGS. 2.1-2.4.

In one or more embodiments disclosed herein, the network device (105) may be a physical device (e.g., the computing system of FIG. 4) that includes persistent storage, memory (e.g., random access memory), one or more processor(s), and two or more physical ports. Examples of the network device (105) include, but are not limited to, a router, a switch, a top of rack (TOR) switch, and a multilayer switch. In one or more embodiments, the network device (105) may be disposed at a remote site (e.g., a customer-defined location or a branch office).

In one or more embodiments, the persistent storage in the network device (105) may include any type of non-transitory computer-readable medium that stores data. For example, the data in the persistent storage may be instructions, which, when executed by one or more processor(s) in the network device (105), enable the network device (105) to perform one or more functions of the network device (105) described below with reference to FIGS. 2.1-2.4.

In one or more embodiments disclosed herein, one or more communication channels may be established between each of the network management service (101), the user device (103), and the network device (105). These communication channels may utilize different types of communication media (e.g., internet connectivity via cellular or Wi-Fi, Bluetooth®, etc.), which allow the network management service (101), the user device (103), and the network device (105) to communicate and transfer data between one another. Establishment of these communication channels is described in more detail below with reference to FIGS. 2.1-3.3.

Turning now to FIG. 1.2, the user device (140) may be the same as or similar to the user device (103) described in FIG. 1.1. In addition to the components discussed in reference to FIG. 1.1, the user device (140) can further include: an onboarding application (142), a first communication interface (144), and a second communication interface (146). The user device (140) may also include a camera (148). Each of the components illustrated in FIG. 1.2 is described below.

In one or more embodiments disclosed herein, the onboarding application (142) is designed to run on a computing device natively. Examples of the onboarding application (142) may include, but are not limited to, a smartphone app, a lightweight app, a user interface (UI) app, a web app, etc. designed to run on a mobile device such as a smartphone, a tablet computer, a laptop computer, and so on.

In one or more embodiments, the onboarding application (142) may be developed and provided by the provider of the network management service (101) and/or the manufacturer of the network device (105) as a human-machine interface for an installer (i.e., the user) of the network device (105) to remotely communicate with the network management service (101). The onboarding application (142) may also be configured as an interface for the network management service (101) to communicate with the network device (105). Additional details of the functions and services provided by the onboarding application are described below with reference to FIGS. 2.1-2.4.

In one or more embodiments disclosed herein, the first communication interface (144) and the second communication interface (146) may each be configured in hardware (e.g., circuitry), software, or any combination thereof. For example, the first communication interface (144) and the second communication interface (146) may each be an integrated circuit (IC) (e.g., a computer chip) or a combination of integrated circuits that enable the user device (140) to utilize one or more types of communication media. In particular, the first communication interface (144) may enable the user device (140) to utilize internet connectivity via cellular or Wi-Fi. The second communication interface (146) may enable the user device (140) to enable Bluetooth® communications.

In one or more embodiments disclosed herein, the user device (140) may include the camera (148) for recording visual images in the form of photographs, film, or video signals. The camera (148) may also be used to scan labels (e.g., quick response (QR) codes, bar codes, etc.) provided on surfaces of other devices (e.g., the network device (105)). In one or more embodiments, the user device (140) may not include the camera (148).

One skilled in the art will recognize that the architecture of the system (100) and of the network device (120) is not limited to the components shown in FIGS. 1.1 and 1.2. For example, system (100) may include multiple ones of the network device (105) being installed. Further, the user device (140) may include components (e.g., a processor, persistent storage, a display, etc.) not shown in FIG. 1.1.

FIGS. 2.1-2.4 show a flowchart of a method for app-assisted ZTP according to some embodiments. The method described with reference to FIGS. 2.1-2.4 may be performed to configure a network device (e.g., the network device 105 shown in FIG. 1.1). The method described with reference to FIGS. 2.1-2.4 may be performed by, for example, a combination of the network device, the network management service (e.g., the network management service 101 shown in FIG. 1.1), and the user device (e.g., the user device 103 shown in FIG. 1.1; the user device 140 shown in FIG. 1.2). Further, while the flowchart in FIGS. 2.1-2.4 is illustrated as a series of steps, any of the steps may be omitted, performed in a different order, additional steps may be included, and/or any or all of the steps may be performed in a parallel and/or partially overlapping manner without departing from the disclosure.

Initially, in Step 200, the user device receives an instruction from a user (e.g., an installer of the network device) to open or run an onboarding application (e.g., the onboarding application 142 shown in FIG. 1.2). In one or more embodiments, the network device may include an instruction manual and/or instruction sheet with instructions for the user to download and install the onboarding application onto the user device.

In Step 202, the user device transmits a request via a first communication interface (e.g., the first communication interface 144 shown in FIG. 1.2) to access the network management service. In one or more embodiments, the first communication interface can provide Internet connectivity via a cellular or Wi-Fi network connected to the Internet. Additionally, the request may be transmitted in response to the user opening the onboarding application on the user device. Alternatively, the request may be transmitted in response to the user selecting a “request connection to network management service” option displayed on a graphical user interface (GUI) of the onboarding application.

In one or more embodiments, at this point, the user has not yet logged into the onboarding application and cannot access any of the functions and services of the onboarding application aside from requesting connection to the network management service.

In Step 204, in response to receiving the access request from the user device, the network management service generates user verification instructions and transmits the user verification instructions to the user device. In one or more embodiments, the user verification instructions may include a one-time URL granting access to a user login page and instructions for the user device to display the one-time URL on the GUI of the onboarding application. The user verification instructions may also include instructions for causing the user device to display a set of login instructions on the GUI.

In Step 206, upon receiving the user verification instructions from the network management service, the user device displays the user verification instructions to the user via the GUI of the onboarding application. For example, in one or more embodiments, the user is presented with the one-time URL generated in Step 204. The user may then use the one-time URL to access a login page that allows the user to log in to the onboarding application using the user's credentials. In one or more embodiments, the log in process may utilize multi-factor authentication (MFA) such as, but is not limited to, using a separate code sent through text message SMS (short messaging service) along with the user's password, a biometric authentication, a user-specific personal identification number (PIN), etc. Other forms of MFA may include, but are not limited to: user ID/Password, single sign on (SSO), SMS or Email secondary authentication, one-time URL sent via SMS, and GPS or reverse IP lookup location services.

In Step 208, the user device obtains user verification information from the user and transmits the user verification information to the network management service. In one or more embodiments, as discussed above in Step 206, the user verification information may include the user's credentials (e.g., a pre-set username and password). If MFA is enabled, the user verification information would also include any additional information required for by the MFA.

In Step 210, the network management service receives the user verification information and verifies the user verification information. In one or more embodiments, the network management service may verify the user verification information against existing information on the user stored within a database of the network management service. This process allows the network management service to authenticate the user and verify that the user is someone who is authorized to install the network device. Once the user verification information is verified, the user is logged into the onboarding application and the onboarding application now has full access to the functions and services of the network management service. Alternatively, in one or more embodiments, the onboarding application may only be provided with partial access to the functions and services of the network management service. Additionally, in one or more embodiments, as an additional factor of authentication, once the user is logged into the onboarding application, a socket is established between the onboarding application and the user device and a certificate is presented to the user device from the onboarding application.

In Step 212, once the user is successfully verified and has logged into the onboarding application, the user device receives instructions to obtain identification information of the network device from the network management service. In one or more embodiments, the instructions to obtain identification information of the network device may include a set of detailed steps for the user to follow for obtaining the identification information. The set of detailed steps are displayed on the GUI of the onboarding application.

In Step 214, in response to receiving the instructions to obtain the identification information of the network device, the user device receives the identification information of the network device from the user. In one or more embodiments, the identification of the network device may be any type of information that can be used to identify and authenticate the network device. For example, the identification may be, but is not limited to, one or more of unique ID (e.g., a model number, a serial number, etc.), a QR code, a barcode, etc.

In one or more embodiments, as a non-limiting example, the set of detailed steps received in Step 212 may include a step instructing the user to scan (through the onboarding application) a QR code of the network device using the camera of the user device. In one or more embodiments, as another non-limiting example, the user may be instructed to enter site information (e.g., an address) of the site at which the network device is being installed.

In Step 216, the user device obtains a geographic location of the user device and transmits the identification information of the network device and the geographic location to the network management service as part of a request for location verification. In one or more embodiments, the geographic location may be obtained automatically by the user device using the current geographical positioning system (GPS) coordinates of the user device. The user device may obtain the geographical location within a predetermined time after receiving the instructions to obtain the identification information of the network device in Step 214. This geographic location of the user device is used to verify that the network device is indeed at a correct installation site. For example, if the network device is stolen during delivery and being installed at a different location, the network management service will be able to prevent installation of the network device by determining that the user device is not at the correct installation location (i.e., installation site).

Although the above example uses a GPS coordinate of the user device to confirm that the network device is being installed at a correct location, one of ordinary skill in the art would appreciate that other forms or authentication and/or information may be used to authenticate a location of the network device and/or user device without departing from the scope of one or more embodiments disclosed herein.

In Step 218, the network management service receives the location verification request from the user device. In one or more embodiments, the location verification request may include any combination of the identification information of the network device and the geographic location. This information received by the network management service is then used in Step 220 to confirm that the network device is physically at the correct installation location (i.e., to verify a location of the network device). For example, the network management service may compare the site information (e.g., an address) entered by the user to the GPS coordinates automatically obtained by the user device to determine whether these two pieces of information match or are within a predetermined distance of one another.

Additionally, in Step 220, the make, model, and other properties of the network device are verified by the network management service using the information included as part of the identification of the network device. This process ensures that the correct type of network device is being installed at the installation site. In one or more embodiments, the network device cannot be installed (e.g., the onboarding application prevents installation of the network device) if the network management service fails to successfully verify either one of the network devices or the location of the network device.

In Step 222, once the network management service successfully verifies the network device and the location of the network device, the user device receives a location verification response in response to the location verification request sent in Step 216. In response to receiving the location verification response, the user device initiates (in Step 224) a communication channel with the network device via a second communication interface (e.g., 146, FIG. 1.2). In one or more embodiments, the second communication interface is Bluetooth®.

In one or more embodiments, the communication channel with the network device may be initiated by the user device transmitting a communication channel establishment request to the user device. In Step 226, the network device receives the communication establishment request from the user device and establishes the communication channel with the user device. Consequently, once the communication channel between the user device and the network device is established, the two devices may communicate with one another using Bluetooth®.

Turning now to Step 228, after the communication channel is established between the user device (namely, the onboarding application of the user device) and the network device, the user device obtains instructions to register the network device with the network management service. In one or more embodiments, the instructions to register the network device with the network management service may be obtained in response to the user pressing a “register” option on the GUI of the onboarding application. In response to receiving the instructions to register the network device, the user device transmits a network device registration request to the network management service. This network device registration request starts the process for bootstrapping the network device to the network management service and the network.

In Step 230, the network management service receives the network device registration request from the user device via the first communication interface of the user device. In response to receiving the network device registration request, the network management service (in Step 232) generates configuration information required for the network device to be registered with the network management service, and transmits the configuration information to the user device using the first communication interface of the user device.

In one or more embodiments, the configuration information for the network device may include one or more sets of instructions and/or configuration files for: (i) bootstrapping the network device to the network and the network management service; and (ii) updating the firmware of the network device to include the latest updates available within the databases of the network management service. For example, assume that the original factory settings of the network device do not include any functions (e.g., dynamic host configuration protocol (DHCP) and/or other service discovery features) that enable the network device to automatically connect to the network. As a result, even if the network device is properly set up and connected by the user, the network device will still not be able to reach the network management service through the network.

In Step 234, the user device receives (e.g., via the onboarding application) the configuration information from the network management service and relays the configuration information to the network device via the communication channel that uses the second communication interface of the user device. At this point, because the network device is fully registered with (i.e., fully bootstrapped to) the network management service, the user device acts (e.g., via the onboarding application) as a relay point for relaying information (e.g., configuration files) from the network management service to the network device. Furthermore, at this point, all communications between the user device and the network management service are relayed using the first communication interface (i.e., internet connectivity via cellular or Wi-Fi) of the user device, and all communications between the user device and the network device are relayed using the second communication interface (i.e., Bluetooth®) of the user device.

In Step 236, the network device receives the configuration information from the user device and processes the configuration information. In one or more embodiments, while processing the configuration information, the network device may transmit information (e.g., bootstrap logs) to the user device for the user device to relay to the network management service. This allows an administrator of the network management service to examine the bootstrap logs and troubleshoot (if necessary) the network device. In one or more embodiments, the administrator may troubleshoot the network device by transmitting commands for the network device to execute to the network device through the user device (e.g., via the onboarding application). In one or more embodiments, data (e.g., the bootstrap logs, telemetric state data, etc.) from the network device may be transmitted to the network management service through an encrypted channel on (i.e., established by) the user device such that the administrator of the network management service may conduct an interactive session with the network device.

In Step 238, upon completion of the processing of the configuration information (i.e., once the network device is successfully bootstrapped to the network management service and fully updated), the network device transmits a completion notification to the user device via the communication channel. In response to receiving the completion notification, the user device (in Step 240) relays the completion notification to the network management service using the first communication interface of the user device.

In one or more embodiments, prior to the network device connecting to (i.e., being successfully registered with) the network management service, a secure boot of the network device (e.g., program clock reference (PCR) measurements and hashes of boot images, etc.) may be passed back to the network management service for verification of a device secure boot prior to any credentials passing to the network device from the network management service.

In Step 242, the network management service receives the completion notification and initiates an establishment of a second communication channel directly with the network device. In one or more embodiments, the second communication channel utilizes internet connectivity communication interfaces (e.g., wired Ethernet connections) of the network management service and the network device. In one or more embodiments, once the second communication channel is established between the network management service and the network device, the network management service transmits a registration completion notification to each of the user device (via the first communication interface of the user device) and the network device (via the second communication channel). At this point, the network device is directly connected to and may directly communicate with the network management service using the second communication channel without using the user device as a relay device.

In Step 244A, the user device receives (e.g., via the onboarding application) the registration completion notification from the network management service that the second communication channel is established. In response, in Step 246A, the user device displays on the GUI of the onboarding application, a notification to the user that the network device is successfully registered with the network management service.

Concurrently, or at any time before or after Step 244A, the network device receives the registration completion notification from the network management service via the second communication channel in Step 244B. In response, the network device notifies the user that the network device is successfully registered with the network management service and initiates a disabling of the communication channel with the user device.

In one or more embodiments, the network device notifies the user of the successful registration by turning on certain lights on a casing of the network device. For example, a light labeled “registered” or “connected” on the casing of the network device may be activated (e.g., turned on). Other forms of notifying the user may be utilized without departing from the scope of this disclosure.

Additionally, in one or more embodiments, the network device initiates disabling of the communication channel with the user device by disabling a Bluetooth® functionality of the network device. Consequently, the network device is no longer discoverable via Bluetooth® by any other devices, which prevents non-authorized individuals from connecting and attempting to configure the network device using other Bluetooth® enabled devices. In one or more embodiments, the Bluetooth® functionality of the network device may only be re-enabled through a factory system reset of the network device. The factory system reset is possible following preset hardware reset procedures developed by the manufacturer of the network device and/or the provider of the network management service.

With the NexGen ZTP, the onboarding process described above can be streamlined to reduce user involvement. With the onboarding process described above, the process for bootstrapping the network device to the network management service and the network is performed with the user device acting as a rely point and all the information, including configuration files, is communicated from the network management service, through the user device, then to the network device.

Referring to FIG. 2.5, in some embodiments, at Step 250, the onboarding application may obtain network device identification information (from the user similar to what is described above in Step 214 or from the network device through the second communication interface of the user device via a Bluetooth® connection with the network device) such as the network device ID, MAC address, serial number, Internet Protocol (IP) address assigned by the IANA, etc. At Step 252, the network device may authenticate the user as an administrator (e.g., through default credentials provided with the network device by the maker of the network device) and send the network device identification information to the user device. At Step 254, the onboarding application may send a request for connection to the network management service. In response, at Step 256, the network management service may recognize the network device based on the network device identification information as described above (e.g., mapping the network device identification information with IDs stored in a centralized database). At Step 256, if the network device is found in the centralized database (and hence the network device is supported by the network management service), the network management service may allow, cause, or direct the onboarding application to download, from a resource location on the cloud-based multi-domain management platform, minimum connection information for the network device. At this time, the network device is not directly connected to the network management service, so the network management service cannot place the network device in an Expected Device Workflow as described above. At Step 258, the onboarding application downloads the minimum connection information for the network device and, at Step 260, sends it to the network device via the second communication interface of the user device via a Bluetooth® connection with the network device. At Step 262, with the minimum connection information, the network device can request connection with the network management service directly. In turn, at Step 264, the network management service can place the network device in an Expected Device Workflow as described above.

This streamlined, app-assisted onboarding process is primarily useful for ISPs and private networks that do not provide the necessary information such as an IP address, etc. when the network device initially gets Internet connectivity. The onboarding application is also streamlined so that its main function is to facilitate a network device to obtain the minimum connection information from the network management service so that the network device can connect to the network management service directly and start an Expected Device Workflow. Once the network device is connected to the network management service, the user device is not involved in the Expected Device Workflow or ZTP of the network device.

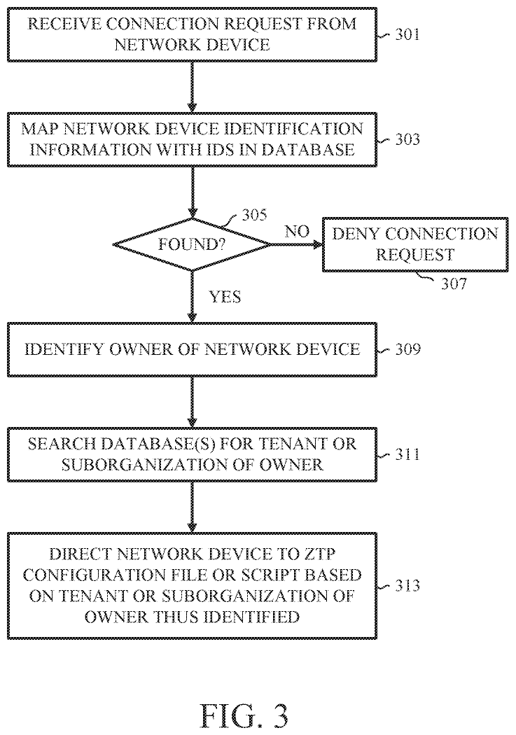

FIG. 3 shows a flowchart that illustrates an example of an Expected Device Workflow in which a new network device can programmatically get itself onboard. As discussed above, for ZTP, the new network device needs to retrieve or obtain a configuration file or script from a designated URL (often at a network address on a ZTP server) for configuring the network device. However, in some cases, the new network device may not have the URL or may not even have the knowledge of where to obtain such a URL. Instead, the new network device may have a default “last resort” URL (see URL-Based Redirect Onboarding) or be provided with minimum connection information (see App-Assisted Onboarding), allowing the new network device to send a request for connection to a network management service (301). The request can contain identification information that identifies the new network device to the network management service, which starts an EDW.

In some embodiments, an EDW engine, which can be part of the cloud-based multi-domain management platform, attempts to recognize the network device by mapping the identification information contained in the request with IDs stored in a centralized database (303). The centralized database stores historical transaction data that includes entries corresponding to sales records of network devices. The sales records include device particulars such as device IDs, serial numbers, and so on, as well as owner data that specifies an owner to which a corresponding network device belongs. If a match (i.e., a matching identifier) is not found (305), the request is denied (307). If a match is found in an entry of the centralized database, the EDW engine can identify an owner of the network device based on information contained in the entry that contains the matching identifier (309).

Often times, the owner would be a hyperscaler or massive company that owns data centers where clusters of server machines are housed and operated to serve multiple tenants. To this end, the EDW engine is operable to search a tenant or suborganization of the owner (311) so as to identify more precisely the correct network on which the new network device is to be placed and for which the new network device is to be configured.

At this point, the EDW engine obtains the knowledge on: 1) the network device itself; 2) the owner of the network device; and 3) the suborganization or tenant for which the network device is to be configured. The EDW engine provides these pieces of information to the network management service. The network management service, in turn, directs the new network device to a configuration file or script corresponding to the tenant or suborganization (313). The configuration file or script may reside at a resource location that belongs to the tenant or suborganization or that is on a ZTP server operating on the premises of the owner. At this time, control of the process moves from the EDW to ZTP, which automatically provisions the new network device using the configuration file or script.

### Correct Tenant Identification

As part of the Expected Device Workflow, an owner of the network device is identified. In some cases, it may be necessary (e.g., the owner is a hyperscaler) to identify which subset of the owner (e.g., which tenant) into which the network device will be placed. The invention provides a way to pinpoint to which tenant a new router belongs, even if the network device is fresh from factory and thus has limited configuration information.

In some embodiments, when a new network device boots up, it communicates with the underlying operating system and performs lookups through the Expected Device Workflow. If the network device is not identified as being in a particular tenant (i.e., not in the owner's database, or the owner did not provide tenant information), then the network management service or another module or logic executing on the cloud-based multi-domain management platform can detect whether the new network device is connected to other routers. This detection can be done by performing, for instance, a directory lookup through a directory service such as one based on the Link Layer Discovery Protocol (LLDP), which is a vendor-neutral link layer protocol based on the IEEE 802 technology and used by network devices for making their identity, capabilities, and neighbors discoverable through a local area network.

In this way, connected network devices can exchange identities among their neighbors in a local network. For example, if there are routers within the local network of the new router, then it can be assumed that all these neighboring routers should be in the same network and, therefore, should belong to the same tenant. Accordingly, the network management service can use tenant information provided by the neighboring routers to determine the tenant or sub-organization for the network device and connect the new network device to the same network as the neighboring routers.

In another embodiment, a tenant may check its neighbors and compare against tenant information provided by the identified owner of the network device and stored in the router database. If the tenant ID information from the owner does not match the neighbors, the network management service can raise a red flag and/or prompt a manual review.

This invention benefits any network device customers who desire ZTP and who would rather not have to spend time and money to preprogram network devices with a designated URL for ZTP. Further, customers who do not have the login information to their network devices for manual configuration can readily configure their network devices programmatically through NextGen ZTP.

As discussed above, embodiments disclosed herein may be implemented using computing devices. FIG. 4 shows a diagram of a computing device in accordance with one or more embodiments disclosed herein. Computing system (400) may include one or more computer processors (402), non-persistent storage (404) (e.g., volatile memory, such as random access memory (RAM), cache memory), persistent storage (406) (e.g., a hard disk, an optical drive such as a compact disk (CD) drive or digital versatile disk (DVD) drive, a flash memory, etc.), communication interface (412) (e.g., Bluetooth® interface, infrared interface, network interface, optical interface, etc.), input devices (410), output devices (408), and numerous other elements (not shown) and functionalities. Each of these components is described below.

In one embodiment disclosed herein, computer processor(s) (402) may be an integrated circuit for processing instructions. For example, the computer processor(s) may be one or more cores or micro-cores of a processor. Computing system (400) may also include one or more input devices (410), such as a touchscreen, keyboard, mouse, microphone, touchpad, electronic pen, or any other type of input device. Further, communication interface (412) may include an integrated circuit for connecting computing system (400) to a network (not shown) (e.g., a local area network (LAN), a wide area network (WAN) such as the Internet, mobile network, or any other type of network) and/or to another device, such as another computing device.

In one embodiment disclosed herein, computing system (400) may include one or more output devices (408), such as a screen (e.g., a liquid crystal display (LCD), a plasma display, touchscreen, cathode ray tube (CRT) monitor, projector, or other display device), a printer, external storage, or any other output device. One or more of the output devices may be the same or different from the input device(s). The input and output device(s) may be locally or remotely connected to computer processor(s) (402), non-persistent storage (404), and persistent storage (406). Many different types of computing devices exist, and the aforementioned input and output device(s) may take other forms.

As shown above, specific embodiments have been described with reference to the accompanying figures. In the above description, numerous details are set forth as examples. It will be understood by those skilled in the art, and having the benefit of this Detailed Description, that one or more embodiments described herein may be practiced without these specific details and that numerous variations or modifications may be possible without departing from the scope of the embodiments. Certain details known to those of ordinary skill in the art may be omitted to avoid obscuring the description.

In the above description of the figures, any component described with regard to a figure, in various embodiments, may be equivalent to one or more like-named components shown and/or described with regard to any other figure. For brevity, descriptions of these components may not be repeated with regard to each figure. Thus, each and every embodiment of the components of each figure is incorporated by reference and assumed to be optionally present within every other figure having one or more like-named components. Additionally, in accordance with various embodiments described herein, any description of the components of a figure is to be interpreted as an optional embodiment, which may be implemented in addition to, in conjunction with, or in place of the embodiments described with regard to a corresponding like-named component in any other figure.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

As used herein, the phrase operatively connected, or operative connection, means that there exists between elements/components/devices a direct or indirect connection that allows the elements to interact with one another in some way. For example, the phrase ‘operatively connected’ may refer to any direct (e.g., wired directly between two devices or components) or indirect (e.g., wired and/or wireless connections between any number of devices or components connecting the operatively connected devices) connection. Thus, any path through which information may travel may be considered an operative connection.

While embodiments described herein have been described with respect to a limited number of embodiments, those skilled in the art, having the benefit of this Detailed Description, will appreciate that other embodiments can be devised which do not depart from the scope of embodiments as disclosed herein. Accordingly, the scope of embodiments described herein should be limited only by the attached claims.

What is claimed is:

1. A method, comprising:
receiving, by logic executing on a server machine of a cloud-based platform, a connection request from a network device, the connection request containing identification information that identifies the network device;
mapping, by the logic, the identification information with identifiers stored in a database;
determining, by the logic, whether a matching identifier is found;
responsive to the matching identifier being found in the database, identifying, by the logic, an owner of the network device from the database using the matching identifier;
determining, by the logic, a tenant or suborganization of the owner; and
directing, by the logic, the network device to a configuration file or script corresponding to the tenant or suborganization for zero touch provisioning of the network device.

2. The method according to claim 1, wherein the database stores historical transaction data that includes entries corresponding to sales records of network devices, each of the entries containing an identifier identifying a respective network device of the network devices and owner data listing a corresponding owner of the respective network device.

3. The method according to claim 1, wherein the configuration file or script resides at a resource location that belongs to the tenant or suborganization.

4. The method according to claim 1, wherein the configuration file or script resides at a resource location on a zero touch provisioning server operating on premises of the owner.

5. The method according to claim 1, wherein the tenant or suborganization is determined by searching the database or another database provided by the owner of the network device for information that identifies the tenant or suborganization.

6. The method according to claim 1, wherein the tenant or suborganization is determined by:
determining whether the network device is connected to any neighboring network device in a local network by performing a directory lookup; and
responsive to the network device being connected to one or more neighboring network devices, using tenant information provided by the one or more neighboring network devices to determine the tenant or suborganization for the network device.

7. The method according to claim 1, wherein the network device comprises a router, a switch, an access point, a firewall, a gateway, or a networking appliance.

8. A system, comprising:
a processor;
a non-transitory computer-readable medium; and
instructions stored on the non-transitory computer-readable medium and translatable by the processor for:
receiving a connection request from a network device, the connection request containing identification information that identifies the network device;
mapping the identification information with identifiers stored in a database;
determining whether a matching identifier is found;
responsive to the matching identifier being found in the database, identifying an owner of the network device from the database using the matching identifier;
determining a tenant or suborganization of the owner; and
directing the network device to a configuration file or script corresponding to the tenant or suborganization for zero touch provisioning of the network device.

9. The system of claim 8, wherein the database stores historical transaction data that includes entries corresponding to sales records of network devices, each of the entries containing an identifier identifying a respective network device of the network devices and owner data listing a corresponding owner of the respective network device.

10. The system of claim 8, wherein the configuration file or script resides at a resource location that belongs to the tenant or suborganization.

11. The system of claim 8, wherein the configuration file or script resides at a resource location on a zero touch provisioning server operating on premises of the owner.

12. The system of claim 8, wherein the tenant or suborganization is determined by searching the database or another database provided by the owner of the network device for information that identifies the tenant or suborganization.

13. The system of claim 8, wherein the tenant or suborganization is determined by:
determining whether the network device is connected to any neighboring network device in a local network by performing a directory lookup; and
responsive to the network device being connected to one or more neighboring network devices, using tenant information provided by the one or more neighboring network devices to determine the tenant or suborganization for the network device.

14. The system of claim 8, wherein the network device comprises a router, a switch, an access point, a firewall, a gateway, or a networking appliance.

15. A computer program product comprising a non-transitory computer-readable medium storing instructions translatable by a processor for:
receiving a connection request from a network device, the connection request containing identification information that identifies the network device;
mapping the identification information with identifiers stored in a database;
determining whether a matching identifier is found;
responsive to the matching identifier being found in the database, identifying an owner of the network device from the database using the matching identifier;
determining a tenant or suborganization of the owner; and
directing the network device to a configuration file or script corresponding to the tenant or suborganization for zero touch provisioning of the network device.

16. The computer program product of claim 15, wherein the database stores historical transaction data that includes entries corresponding to sales records of network devices, each of the entries containing an identifier identifying a respective network device of the network devices and owner data listing a corresponding owner of the respective network device.

17. The computer program product of claim 15, wherein the configuration file or script resides at a resource location that belongs to the tenant or suborganization.

18. The computer program product of claim 15, wherein the configuration file or script resides at a resource location on a zero touch provisioning server operating on premises of the owner.

19. The computer program product of claim 15, wherein the tenant or suborganization is determined by searching the database or another database provided by the owner of the network device for information that identifies the tenant or suborganization.

20. The computer program product of claim 15, wherein the tenant or suborganization is determined by:
determining whether the network device is connected to any neighboring network device in a local network by performing a directory lookup; and
responsive to the network device being connected to one or more neighboring network devices, using tenant information provided by the one or more neighboring network devices to determine the tenant or suborganization for the network device.
